(19) United States
(12) Patent Application Publication
(10) Pub. No.: US 2018/0195434 A1
(43) Pub. Date: Jul. 12, 2018

(54) INTERNAL COMBUSTION ENGINE

(71) Applicant: Wladyslaw Kurek, Lincolnwood, IL (US)

(72) Inventor: Wladyslaw Kurek, Lincolnwood, IL (US)

(21) Appl. No.: 15/796,284

(22) PCT Filed: Apr. 27, 2016
(86) PCT No.: PCT/US2016/029577

§ 371 Date: Oct. 27, 2017

Related U.S. Application Data
(60) Provisional application No. 62/153,933, filed on Apr. 28, 2015.

(51) Int. Cl. F02B 75/32; F01B 9/06; F02B 75/04; F02B 75/06

(52) U.S. Cl. CPC F02B 75/32; F01B 9/06; F02B 75/047; F02B 75/06; F02B 75/048

(57) ABSTRACT

An improved reciprocating internal combustion engine converts a larger percentage (than a conventional engine) of the linear force exerted by the piston into rotation of the crankshaft when the combustion pressures are at maximum, high or intermediate levels. This increased conversion results in more power per cycle, when compared to conventional engines of comparable size. The improved engine includes an engine block, a cylinder within the engine block, a piston slidably positioned within the cylinder for a reciprocating motion, a crankshaft, a connecting rod and a torque arm. One side of the connecting rod is pivotally mounted to the piston and on the other side to the torque arm. The torque arm is also operatively rigidly connected to a template that is mounted to the engine block. The template guides the movement of the torque arm along a predetermined path. The template is configured to position the torque arm at an angle with respect to the radius of the crankshaft at the pivot point such that the combined value of vectors that contribute to turning the crankshaft are significantly larger than that of the turning vectors in a conventional engine, when the combustion pressure in the cylinder is at the maximum high or intermediate levels.

### CROSS REFERENCE TO RELATED APPLICATIONS

This application claims the benefit of prior PCT Application No. PCT/US16/029577 filed on Apr. 27, 2016, which is incorporated by reference in its entirety.

### BACKGROUND

This invention relates to internal combustion engines. More particularly, it relates to reciprocating internal combustion engines that include crankshafts.

A conventional commercially available internal combustion engine uses a connecting rod to transform linear motion of a reciprocating piston into a rotary motion of a crankshaft. The piston moves a cylinder between the top dead center (TDC) position and the bottom dead center position (BDC). As the piston moves within its cylinder in response to expanding gases of combustion, rotary motion is imparted to the crankshaft through the connecting rod. One end of the connecting rod is pivotally secured to the piston, while the other end of the connecting rod is pivotally connected to (usually rotatably journeyed about) an offset throw of the crankshaft. When multiple cylinder arrangements are used, the crankshaft is extended to include an additional offset throw for each connecting rod In a conventional internal combustion engine, the crankshaft is supported by main bearings, and at the end of the crank throw, a crank pin holds the connecting rod.

In a conventional internal combustion engine, the maximum pressure generated by combustion of the fuel occurs shortly after the top of the stroke, i.e., shortly after the piston passes the top dead end center (TDC). The maximum pressure in most conventional internal combustion engines occurs when the crank throw is about 10° past the position that corresponds to the TDC position of the piston. At the maximum pressure position, the percentage of the force generated by combustion, which is converted into rotational energy of the crankshaft, is relatively small because a relatively small component of the total force of the piston is directed to imparting rotation of the crankshaft. The component of the total force generated by combustion on the piston that is directed to imparting rotational movement of the crankshaft is increased as the piston moves toward the low dead center position (LDC). However, as the piston moves toward the LDC position, the pressure generated by the combustion gases continuously decreases. Accordingly, in conventional engines, the highest percentage of conversion of linear force generated by the piston in response to combustion into rotation of the crankshaft occurs when the linear force is at relatively low levels.

The reasons why conventional engines provide low conversion rates at maximum combustion pressures can be shown by analysis of the forces transmitted between components of a conventional engine. FIG. 1 schematically illustrates a typical conventional reciprocal combustion engine. As shown in FIG. 1, the engine 5 includes: a piston 10, a connecting rod 15, and a crankshaft 20. The connecting rod 15 is pivotally connected to the piston by a piston pin 25 and is pivotally connected to a throw 27 of a crankshaft 20 by a crankshaft pivot 29.

When fuel is ignited in the cylinder, the resulting combustion pressure moves the piston in the cylinder linearly towards the BDC position. FIG. 2 shows the pressure in a cylinder as a function of the angle of the crankshaft measured from the TDC position, such that at when the piston is at the TDC position, the angle is zero and when the piston is at the BDC position the angle of the crankshaft throw is 180°. As shown in FIG. 2, in a typical conventional internal combustion engine, the maximum pressure is generated by combustion when the throw pivotally connected to the connecting rod is at an angle of about 10°. This angle is designated in FIG. 1 as “Alpha.” The conversion percentage of the linear force of the piston into rotational force of the crankshaft when the crankshaft is at the angle Alpha can be calculated as follows (excluding friction). As shown in FIG. 1, the linear force exerted by the piston 10 onto the connecting rod 15 is designated as Fₖ. This force is set at 1 (i.e. 100%). The angle between the longitudinal axis of the cylinder and the connecting rod is designated in FIG. 1 as Beta. In FIG. 1, the angle Beta is 2.88°. To determine what percentage of the linear force k that is converted into the rotational force can be calculated using the following formula:

$${F}_{0} = {F}_{k} \cdot sin ( α + β ) = \frac{F \cdot sin ( α + β )}{cos β}$$

When, as shown in FIG. 1, Fₖ=1, α=10° and ß=2.88°, the calculations yield the following result:

F₀=sin(12.88°)=0.2229

These calculations show that is the conventional engine schematically shown in FIG. 1, at the maximum pressure in the cylinder, only about 22.29% of the linear force exerted by the piston 10 is converted into rotational force on the crankshaft, excluding frictional losses.

There is, therefore, a long felt but still unsatisfied need for an internal combustion engine that converts a larger percentages of the linear force of the piston into rotational energy that drives the crankshaft, at the time the combustion pressures generated by combustion is at relatively high levels, and especially when the pressures are at or near the maximum levels.

Accordingly, it is an object of the present invention to provide an internal combustion engine that more efficiently converts linear force of the piston, which generated by combustion, into a rotational movement of the crankshaft.

Another object of the present invention is to provide an internal combustion engine that converts a larger proportion of the force generated by combustion into rotational energy of the crankshaft when the pressures on the piston from fuel combustion are at or near the highest levels.

A further object of this invention is to provide a reciprocating internal combustion engine that during each cycle provides to the crankshaft a higher power per volume of the cylinder than the power provided by conventional commercially available reciprocating internal combustion engines and therefore, increases fuel economy.

Yet another object of the present invention is to provide a reciprocating internal combustion engine that runs smoother than conventional engines.

These and other objects of the present invention will become more apparent to those skilled in the art after studying the following disclosure.

### BRIEF DESCRIPTION OF THE DRAWINGS

FIG. 1 is a schematic of a conventional internal combustion engine that includes: a cylinder, a piston, a connecting rod and a crankshaft; the linear force transmitted from the piston and rotational force on the crankshaft are shown on the drawing.

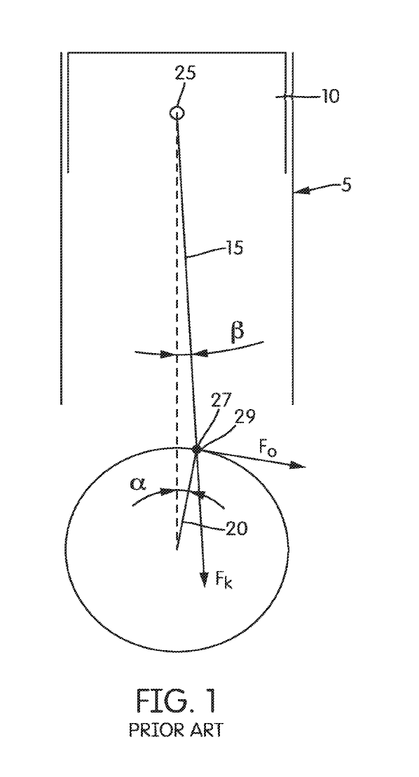

FIG. 2 is a graph of pressures in mega Pascals (MPa) generated in a cylinder of a conventional engine during a cycle as a function of the angular throw location of the crankshaft, with the 0° crankshaft angle corresponding to the piston position at the TDC.

FIG. 3 is a schematic of an embodiment of the present invention, which schematically illustrates the arrangement of components of an engine that is constructed in accordance with one embodiment of the present invention and which shows angles and component forces that are transmitted to turn the crankshaft.

FIG. 4 is a graphical comparison of estimated percentages of linear forces converted to rotational forces (excluding friction) during an engine cycle using a conventional engine shown (in FIG. 1) and an engine constructed in accordance with the present invention, which is shown in FIG. 3.

FIG. 5 is a schematic cross-sectional view of an engine constructed in accordance with another embodiment of the present invention, with the piston at the top dead end center (TDC).

FIG. 6 is a schematic cross-sectional of the engine of FIG. 5 with the piston at the maximum combustion pressure position.

FIG. 7 is a schematic cross-sectional view of the engine of FIG. 5, with the piston below the maximum combustion pressure position.

FIG. 8 is a schematic cross-sectional view of the engine of FIG. 5 with a piston further away from the TDC position than that in FIG. 7.

FIG. 9. is a schematic cross-sectional view of the engine of FIG. 5 with a piston near the BDC position.

FIG. 10 is a schematic cross-sectional view of an engine constructed in accordance with a further embodiment of the present invention, with the piston at TDC position.

FIG. 11 is a schematic cross-sectional of the engine of FIG. 10 with the piston slightly below top dead center (TDC) position.

FIG. 12 is a cross-sectional view of the engine of FIG. 5 with a piston near the BDC position.

FIG. 13 is a schematic diagram illustrating another embodiment of the engine constructed in accordance with the present invention, showing component forces at the maximum pressure of the engine cycle.

FIG. 14 is a schematic diagram of the embodiment shown in FIG. 13 illustrating several positions of the torque arm and the crankshaft pivot during an engine cycle.

### SUMMARY OF THE INVENTION

In accordance with one aspect of the patent invention an improved reciprocating internal combustion engine includes: an engine block, a cylinder within the engine block, a piston slidably disposed within the cylinder, and a crankshaft. A connecting rod is pivotally mounted to the piston at one end. The other end of the connecting rod is pivotally connected to a torque arm. The torque arm, in turn, is operatively connected to a template that is rigidly mounted to the engine block. The template guides the path of movement of the torque arm along a predetermined path. The torque arm is pivotally connected to a crankshaft. The template, the connecting rod, the torque arm and the crankshaft are configured such that an increased percentage of forces generated by combustion on the piston, are converted into rotational energy of the crankshaft when pressures created by combustion are at high levels.

In accordance with another aspect of the present invention, an improved reciprocating internal combustion engine includes: an engine block, a cylinder within the engine block, a piston slidably positioned within the cylinder, and a crankshaft. A connecting rod is pivotally connected to the piston at one end and to a torque arm on the other end. The torque arm is also pivotally connected to the throw of the crankshaft. A template rigidly mounted to the engine block guides the movement of the pivot between the torque arm and the connecting rod along a predetermined path. The cylinder, the connecting rod, the torque arm, the crankshaft and the templates are configured to convert a higher percentage (than that of conventional engine) of the forces exerted by the piston when the force of combustion on the piston is at or near the maximum levels.

In accordance with a further aspect of the present invention, an improved reciprocating internal combustion engine includes: an engine block, a cylinder within the engine block, a piston slidably disposed in the cylinder, and a crankshaft. The crankshaft is operatively connected to the piston by a combination of a connecting rod and a torque arm. One end of a connecting rod is pivotally mounted to the piston and the other end of the connecting rod is connected to one end of the torque arm by a pivot that includes a roller. A template, fixedly mounted to the engine block, includes a channel. The channel receives the roller and guides the movement of the roller along a path that includes at least one accurate segment. The other end of the torque arm is pivotally mounted to a crankshaft. The connecting rod, the torque arm and the crankshaft are configured such that the torques on the crankshaft are at high levels when high pressures are generated by the combustion gases in the cylinder. The template, the torque arm and the crankshaft are also configured such that the axis of the segment of the channel in which the roller is located and of the longitudinal axis of the piston rod are approximately aligned when the maximum combustion pressure is reached in the cylinder.

Other aspects of the present invention will become apparent to these skilled in the art upon studying these disclosures.

### DETAILED DESCRIPTION

The present invention is for an internal combustion engine that more efficiently (than conventional engines) converts linear forces of a piston into rotational forces that drive a crankshaft of the engine, especially when the pressure in the cylinder is a high or maximum levels.

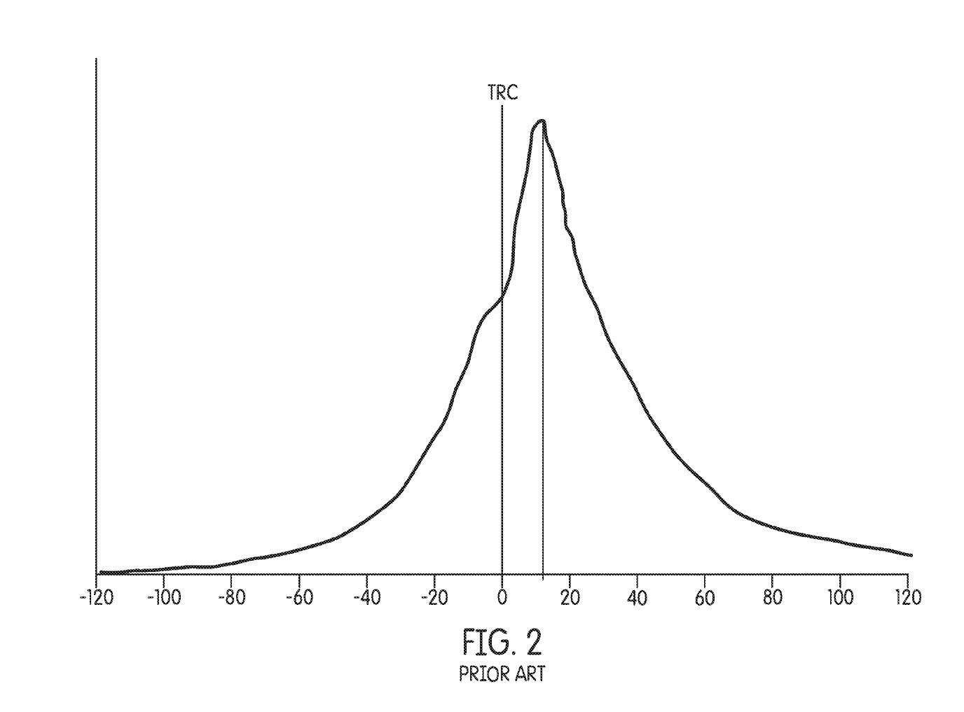

It is well known in the art that in a conventional internal combustion engine, a maximum pressure is generated shortly after combustion takes place, i.e., shortly after the piston passes the top dead center (TDC) position. After the maximum combustion pressure is achieved, the pressure in the cylinder quickly decreases as the piston moves toward the low dead center (LDC) position. A typical pressure profile in a cylinder of an internal reciprocal combustion engine is shown in FIG. 2. The present invention improves the efficiency of an engine by providing higher conversion of the linear forces on the piston, generated in the cylinder by combustion, into a rotational forces that drive the crankshaft by increasing the torque (over that of the conventional engines), when the pressures in the cylinder are at high levels, and especially when the pressure in the cylinder is at or near maximum.

The present invention can be used in connection with any type of reciprocating internal combustion engine, including (without limitation) a two-stroke engine, a four stroke engine, a five stroke engine and a six stroke engine. However, the preferred application is for a four stroke engine.

The present invention can be used for internal combustion engines having one or more cylinders. The preferred use is for engines having eight, six or four cylinders.

The present invention can be used in connection with internal combustion engines in which the combustion is initiated by an electrical discharge (spark) as well as in connection with diesel engines in which the combustion is initiated by compression of the fuel. Any fuel that is used in a corresponding conventional engine can be used in the engine of the present invention. The engine of the present invention allows the use of lower quality fuels because it has a higher efficiency in converting the force generated by the combustion of the fuel into rotational motion of the drive shaft.

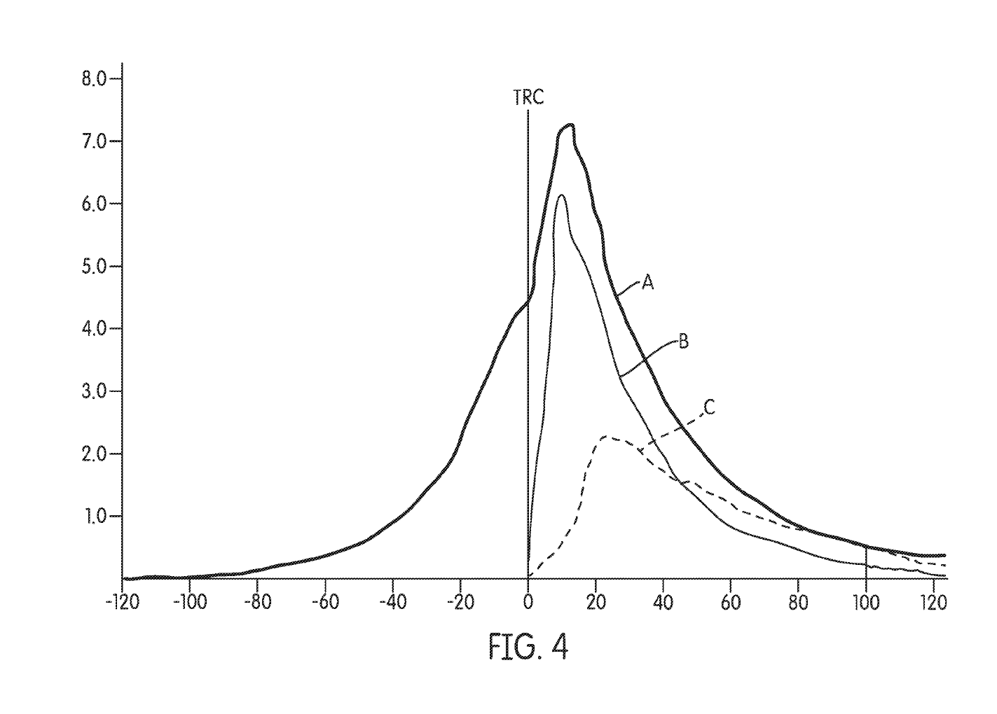

In operation, as shown in FIG. 2, shortly after the cylinder passes the TDC position the combustion gases exert the maximum pressure on the piston in the cylinder. At the maximum pressure position of the piston and while the pressure remains high, the components of the improved engine of the present invention are configured to convert more of the resulting linear force exerted by the piston into a rotational force on the crankshaft than the conventional engines. Specifically, when the piston in the cylinder is at the position corresponding to the maximum combustion pressure level and of high pressures, the total of the component vectors that achieve a torque for rotation of the crankshaft are significantly higher than that of a corresponding conventional engine. The desired higher torque is achieved by maximizing the sum of the vectors that contribute to the rotation of the crankshaft. In the preferred embodiments these angles include (1) angle Alpha that is between the line extending from the center of the crankshaft to the crankshaft pivot; (2) angle Beta that is the angle between the longitudinal axis of the cylinder and the longitudinal axis of the connecting rod, (3) angle Delta which is between the longitudinal axis of the template channel and the longitudinal axis of the connecting rod; and, (4) angle Gamma that is between the longitudinal axis of the template channel and longitudinal axis of the torque arm. At the maximum pressure in the cylinder, conversion rate measured by the sum of the vectors that contribute to the rotation of the crankshaft should preferably be more than 25%, more preferably more than 50% and most preferably more than 80% of the linear force exerted by the piston (excluding frictional losses). The present invention increases the torque at the maximum pressure and high pressures over the torque in a corresponding conventional engines. The increased torques cause higher conversions of linear forces of the piston into rotation of the crankshaft FIG. 4 shows a comparison of estimated conversions of energy produced by conventional engine “C” and an engine of the present invention “B” during the power stroke of the engine (“A”). The conversion is higher than that in the conventional engine from about 10° to about 45° while the pressures in the cylinder are at the maximum and at high levels.

As shown in FIG. 4, the maximum pressure of about 7.3 MPa occurs in the cylinder when the crankshaft is at the Alpha angle of about 10°. The pressure drops to 1.7 MPa when the angle Alpha is about 35°. As shown in FIG. 4, at high pressures (i.e. pressures that are within 50% of the maximum pressure) the engine constructed in accordance with the present invention convers significantly more linear forces into rotation of the crankshaft than a conventional engine. Even at intermediate pressures (from about 3.6 MPa to 1.8 MPa) in the cylinder (i.e. pressures that are between 25% and 50% of the maximum pressure), an engine constructed in accordance with the present invention converts more linear forces into rotation of the crankshaft than a conventional engine. At low pressures (i.e. pressures that are less than 25% of the maximum pressure) a conventional engine converts a higher percentage of linear forces into rotation of the crankshaft. However, the conversions at lower pressures are less important to the overall power in a cycle As can be seen in FIG. 4, the total conversion for the power stroke is significantly higher for engines of the present invention than for conventional engines.

To reduce friction at the maximum pressure, the axial axis of the piston rod can be axially aligned with the segment of the longitudinal axis of the cylinder (parallel to the cylinder walls) when the combustion pressure is at or near the maximum level at high levels or intermediate The engine of the present invention can include a conventional fly wheel. As the piston reaches its low dead end center (LDC) position, the momentum of the fly wheel helps to move the piston upward and provides for smoother operation of the engine.

To reduce friction between the template and the member that slides on the template along a predetermined path, lubrication can be provided. To further decrease the friction, the part of the torque arm, which interacts with the template, can be equipped with a roller or a plurality of rollers. The template preferably includes a channel which is in the shape of the desired path and which can accommodate a roller or a plurality of rollers. The channel preferably has a plurality of sections and preferably has at least one accurate section. Preferably, the roller or rollers slide on an inside surface of the channel.

### DESCRIPTION OF THE PREFERRED EMBODIMENTS

To further illustrate the present invention, the construction and operation of the preferred embodiments will be described. The description of the preferred embodiments is provided merely to further illustrate the present invention when the piston is and is not intended to limit the scope of the invention in any manner.

### First Preferred Embodiment

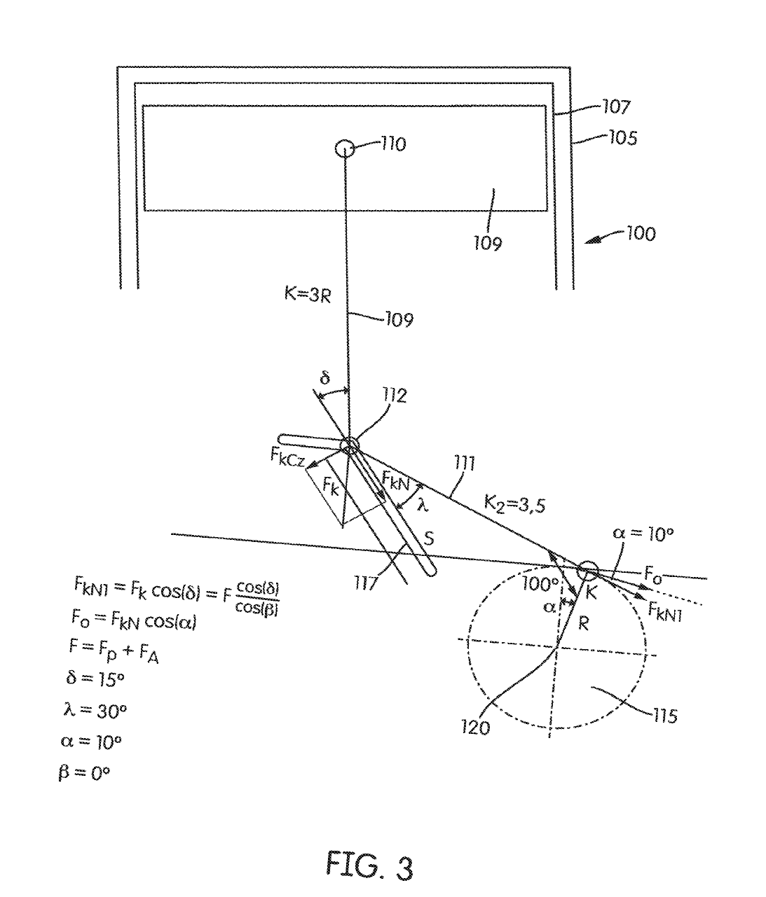

FIG. 3 schematically depicts an engine construed in accordance with the first preferred embodiment of the present invention shown at the maximum pressure position. An engine generally designated by numeral 100, includes an engine block 105. A cylinder 107 is defined within the engine block 105. A piston 109 is slidably mounted in the cylinder 107. A connecting rod 109 is pivotally attached by a piston pivot 110 at one end to the piston 107 and is pivotally attached to a torque arm 111 by a piston pivot 112. The other end of the torque arm is pivotally attached to the throw 113 of a crankshaft 115. The movement of the common pivot 112 is guided by a channel 117 in a template 119 that is rigidly mounted to the engine block 105. As shown in FIG. 3, an angle Alpha is defined between the line extending from the center 120 of the crankshaft to 115 the extending the line parallel to the central axis of the piston and the line between the center 120 to the pivot 113. An angle Beta defined between the longitudinal axis of the connecting rod 109 and the longitudinal axis of the cylinder 107, is zero. An angle Delta is defined between the longitudinal axis of the connecting rod 109 and the longitudinal axis of the channel 117. An angle Gamma is defined between the longitudinal axis of the channel 117 and the longitudinal axis of the torque arm 111.

FIG. 2 shows forces that are generated in the cylinder during a cycle. For the engine shown in FIG. 3, the following formulas can be used to determine the percentage of the force generated by the piston that is converted into rotational energy (excluding fractional losses).

$${F}_{k N 1} = {F}_{k } cos ( δ ) = F \frac{cos ( δ )}{cos ( β )} {F}_{0} = {F}_{kN} cos ( α ) F = {F}_{p} + A$$

In the embodiment shown in FIG. 3, the angles are:

δ=15°

λ=30°

α=10°

β=0

When the initial force is set as 1 (100%), the formula yields the following result:

F_{kN}=cos 15°=0.9659

Fₖ₁=0.9659·cos 30°=0.8365

F₀=0.8365·cos 10°=0.8237 82.37%

These calculations indicate that 82.37% of linear force exerted by the piston is converted into rotation of the crankshaft (excluding frictional losses).

### Second Preferred Embodiment

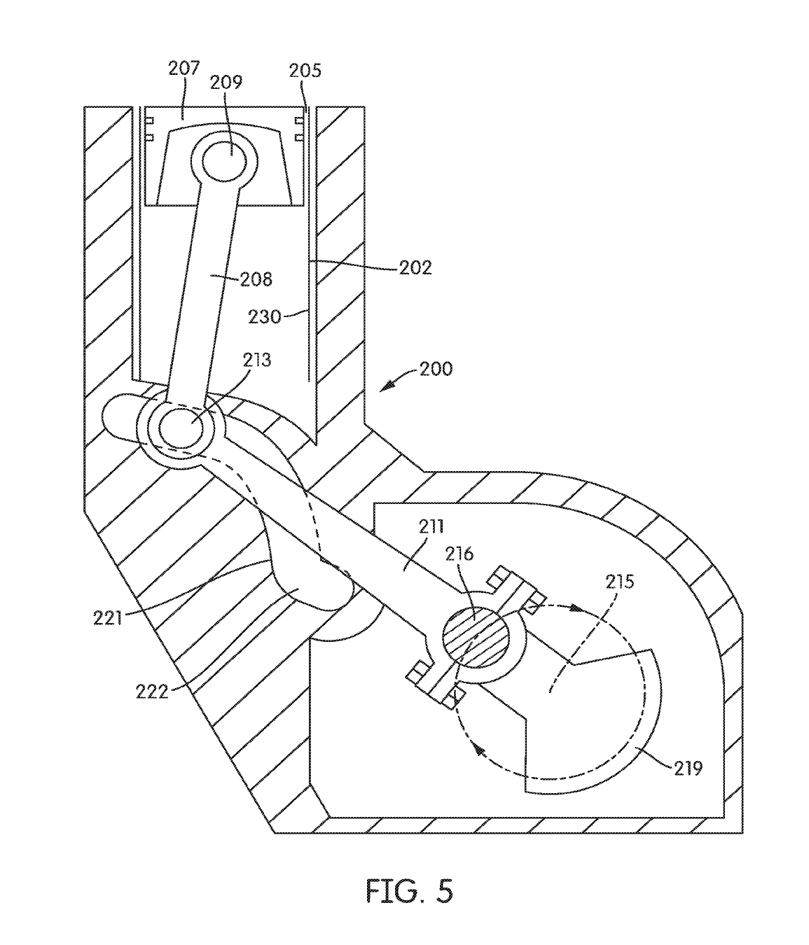

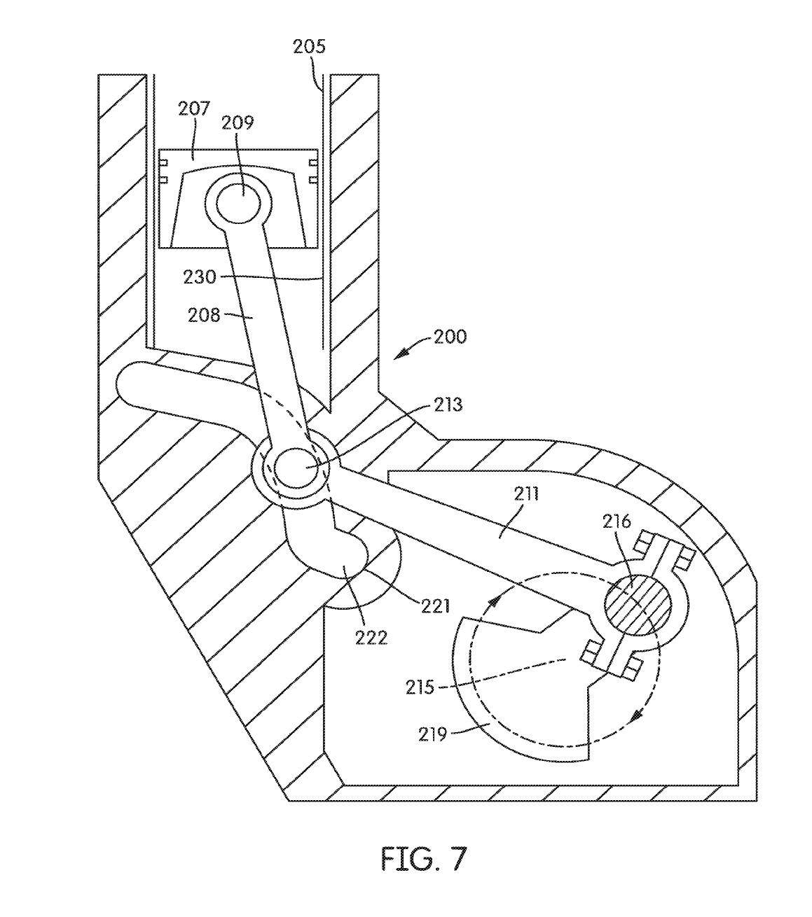

A second embodiment of the present invention is illustrated in FIGS. 5-9. Referring now to FIG. 5, an engine is generally designated by a numeral 200. The engine 200 includes an engine block 202 which defines a cylinder 205. A piston 207 is slidable mounted in the cylinder 205. The cylinder 205 is connected to one end of a piston rod 208 by a piston pivot 209. The other end of the piston rod 208 is pivotally connected to a torque arm 211 by a pivot 213. The torque arm 211 is rotatably mounted to a crankshaft 215 by 216 pivot. The crankshaft 215 is rigidly connected to a fly wheel 219.

The piston pivot 213 is operatively connected to a template 221 which is integral with the engine block 202 and has a channel 222. As shown in FIG. 5, the piston pivot 212 slides in a channel 223 defined in the template 221. The piston pivot 213 can include a roller (not shown) to reduce friction.

In operation, FIG. 5 shows the piston near at the top dead center position as the piston begins to move down from its top dead end center position. The engine is preferably configured such that when the maximum pressure is exerted by the combustion gases on the piston 207, the longitudinal axis of the piston rod 208 is approximately parallel to the longitudinal axis of the cylinder 205, defined by cylindrical walls 230 of the cylinder 205.

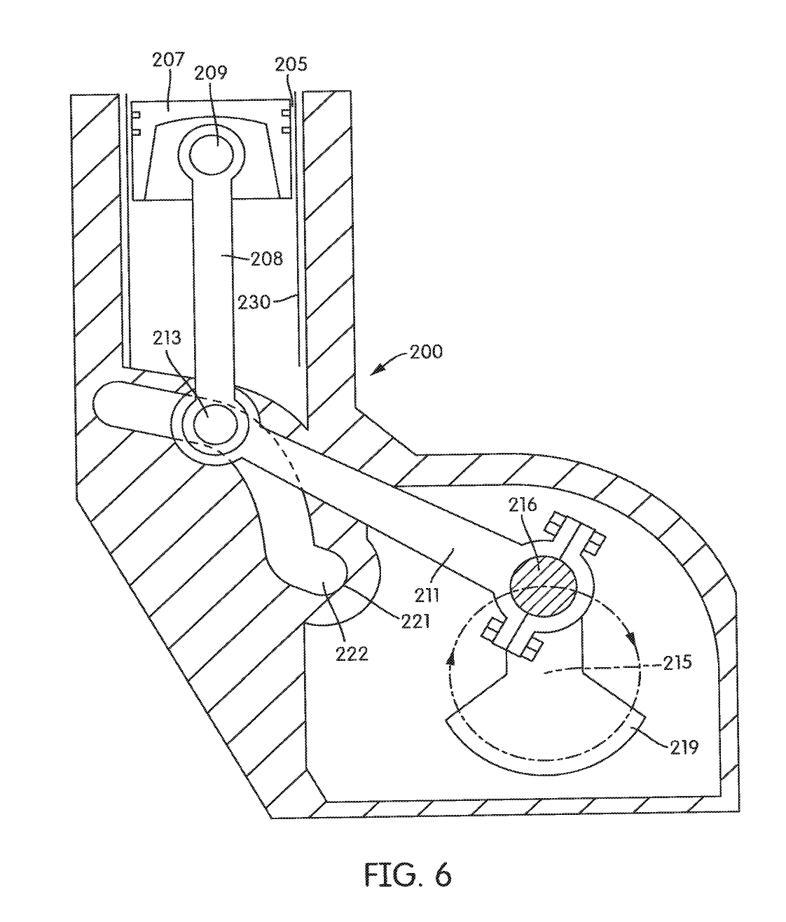

After the fuel in the cylinder is ignited, combustion gases exert pressure on the top of the piston 207. The pressure of piston 207 causes it to move down. As illustrated in FIG. 6, the movement of the piston 207 causes the piston rod 208 to rotate the guide torque arm 211. This rotation, in turn, causes the rotation of the crankshaft 215 by the torque force applied at the pivot 216.

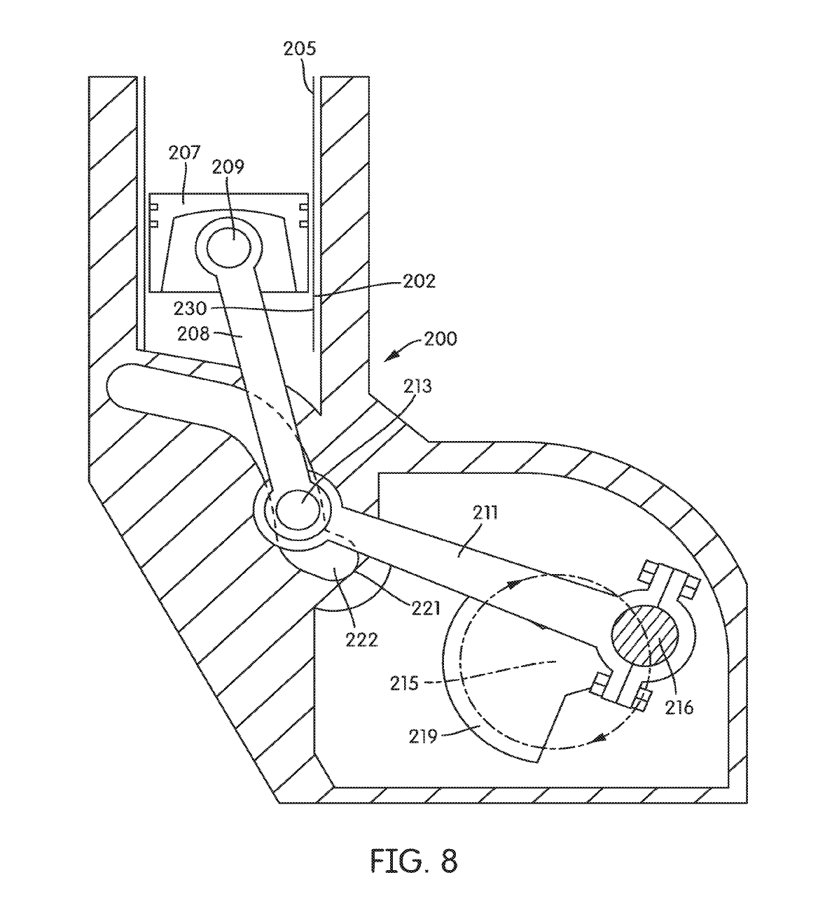

As shown in FIG. 8, further movement of the piston 207 caused by the pressure of the combustion gas, causes the movement of the piston pivot 213 along the channel 222 of the template 221. This movement, in turn, causes movement of the torque arm 211 that rotates the crankshaft at the pivot 216.

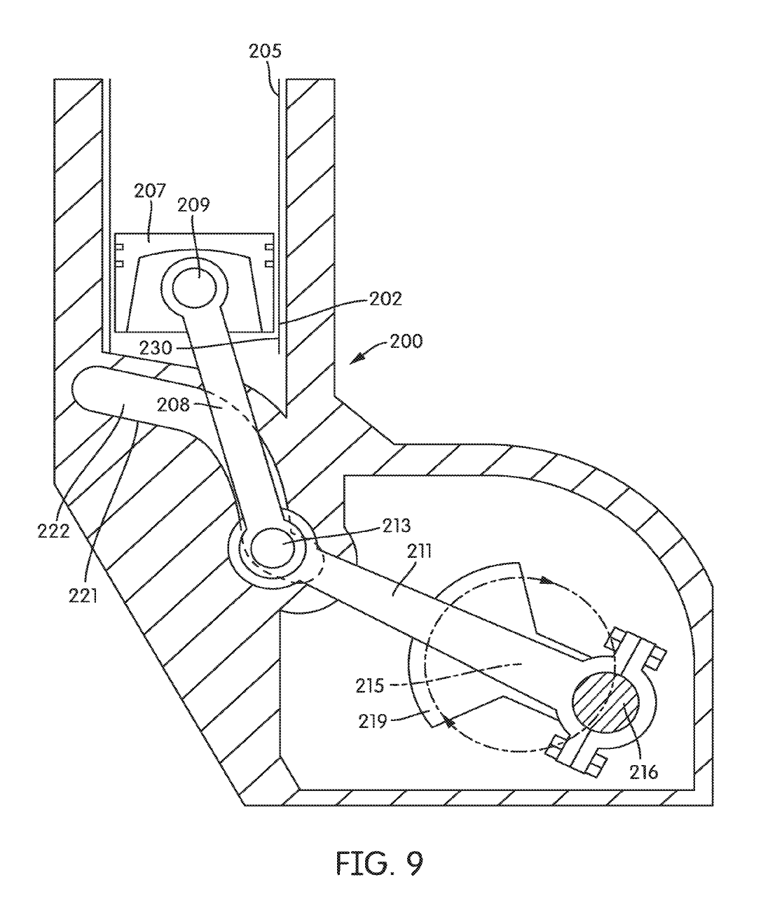

In FIG. 9, the piston is approaching the low dead center (LDC) position, causing further rotation of the crankshaft. Once the LDC position is reached the momentum or inertia of the crankshaft together with the momentum of the flywheel move the pivot 213 upward in the channel 222. This movement causes the piston rod 208 to move the piston toward the top dead center position (TDC) begins.

### Third Preferred Embodiment

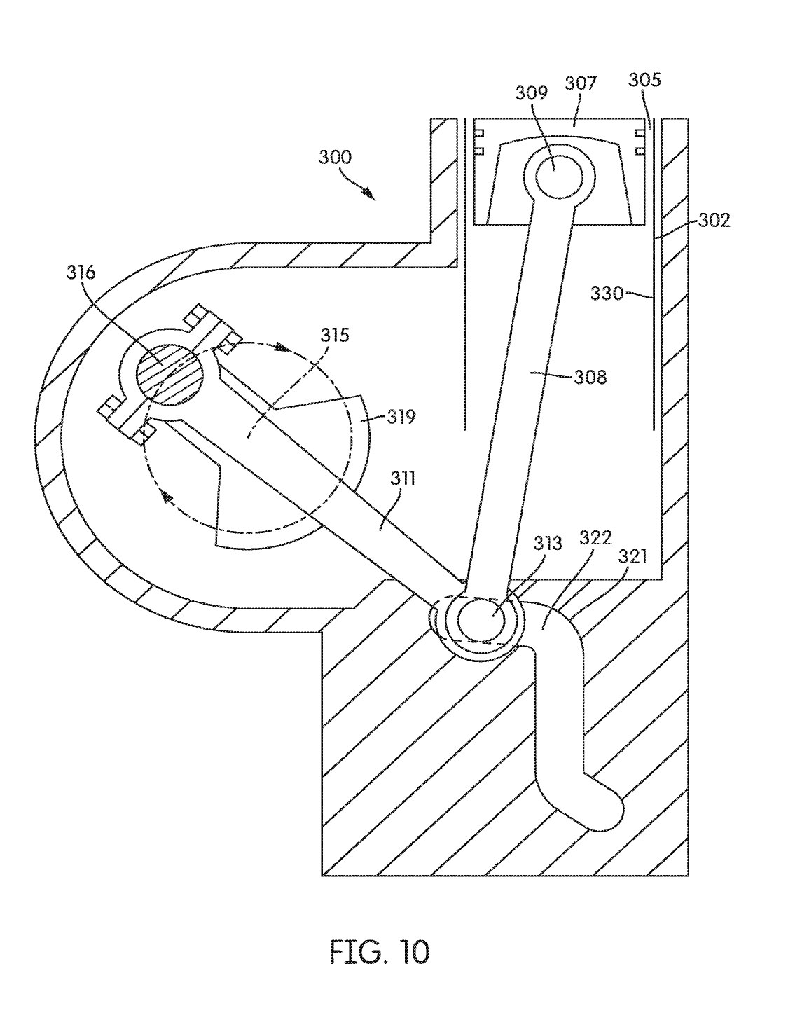

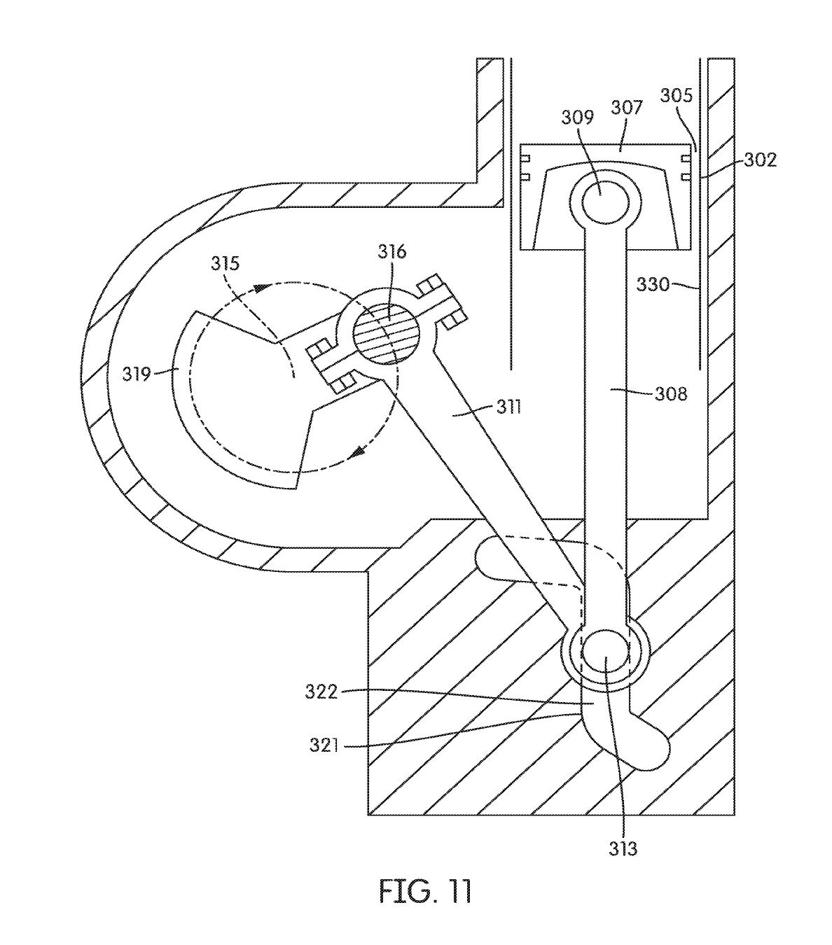

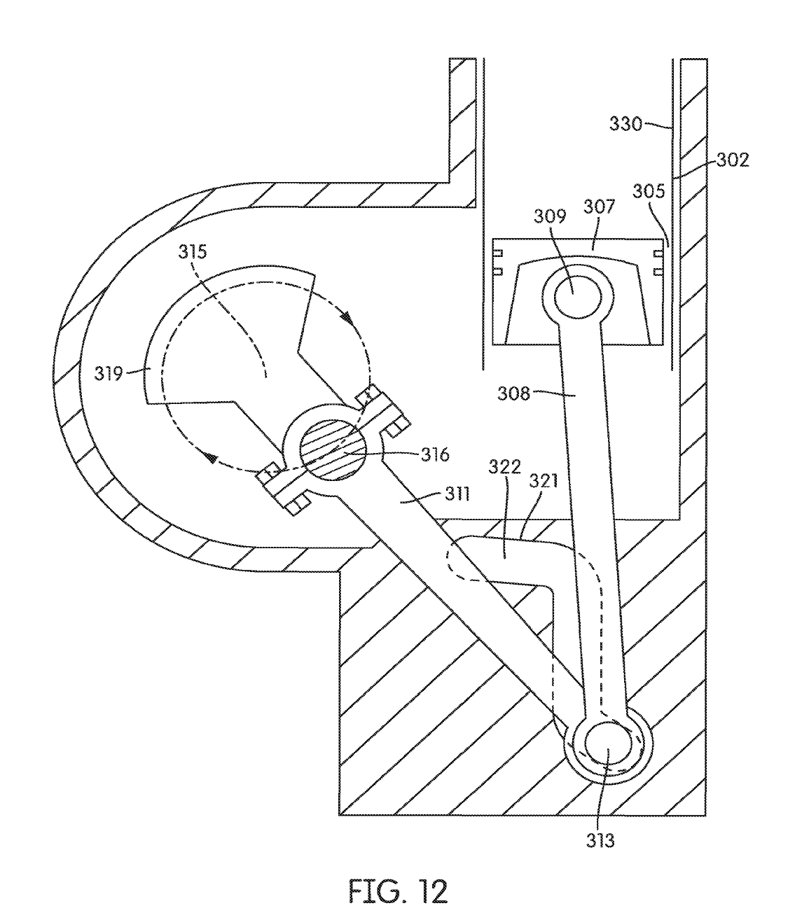

The third preferred embodiment is schematically depicted in FIGS. 10-12. The parts of the engine corresponding to the parts of the engine in the second embodiment are labelled using the same last two digits but in the first digit “2” is replaced by “3”. FIG. 10 shows the piston 307 near the top dead center position. FIG. 11 shows the piston 307 near the middle of the power stroke and FIG. 12 shows the piston near the bottom dead center position.

### Fourth Preferred Embodiment

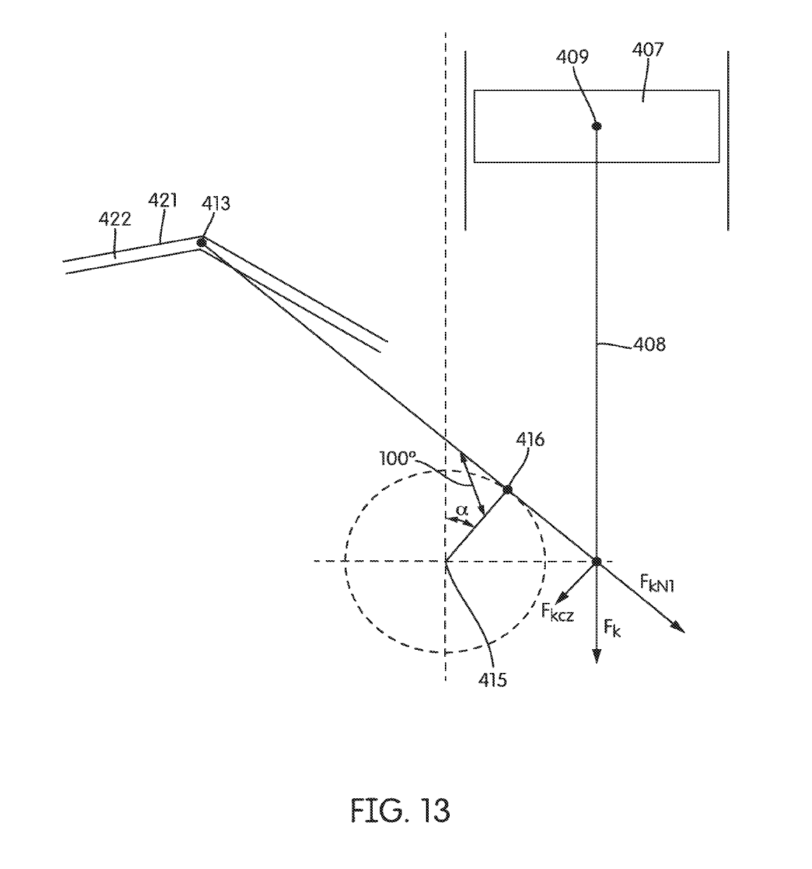

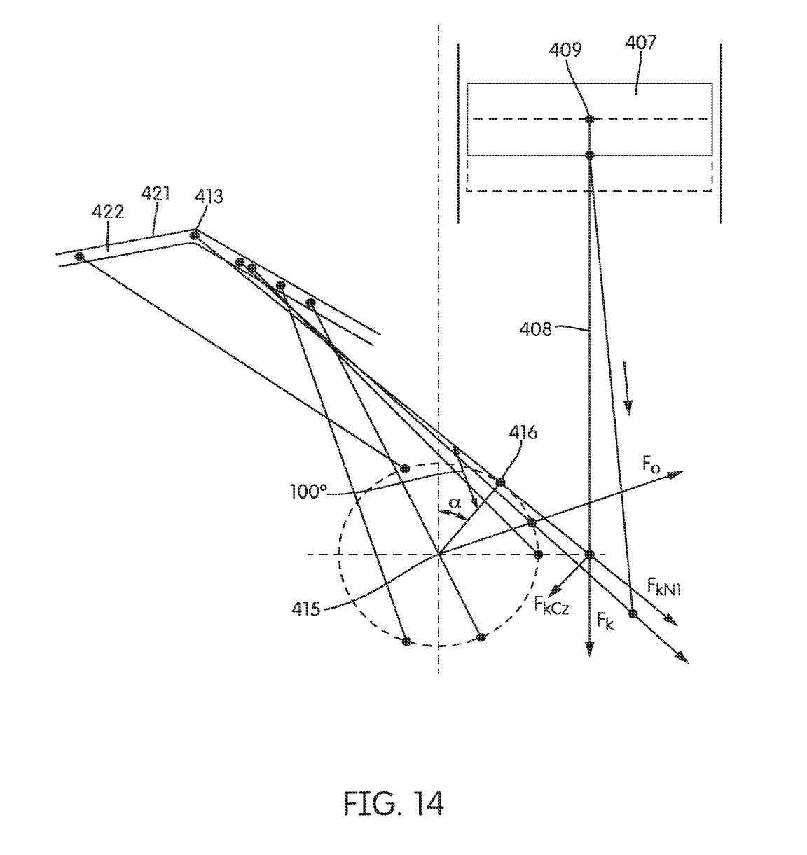

The fourth preferred embodiment of the present invention is schematically depicted in FIGS. 13-14. The parts of the engine depicted in these figures have corresponding designations to those of the second embodiment except that the number “2” is replaced by numeral “4”. The torque arm 411 in this embodiment is pivotally attached to the throw 416 of the crankshaft of 415 by a mid-section pivot 430. One end of the torque arm 411 is pivotally attached to crankshaft 408. The other end of the torque arm 411 is operatively connected to a template 421 which defines a channel 422. A member 432 rides inside the channel 422. To reduce friction the member 432 preferably includes a roller or a plurality of rollers.

FIG. 14 shows positions of the torque arm in the embodiment of FIG. 13 as the piston moves within the cylinder, imparting rotation of the crankshaft.

1. An improved reciprocating internal combustion engine, comprising:
(a) an engine block;
(b) a cylinder within said engine block;
(c) a piston slidably disposed within said cylinder for rectilinear reciprocal movement;
(d) a crankshaft;
(e) a connecting rod having an inner end pivotally mounted to said piston and having an outer end;
(f) a torque arm having a piston rod end and a crankshaft end said torque arm pivotally connected to the other end said connecting rod at a common pivot and pivotally connected to said crankshaft;
(g) a template mounted to said engine block, said template operatively connected to said torque arm and to said connecting rod at said common pivot, said template guiding the movement of the common pivot along a predetermined path, the crankshaft end of said torque arm pivotally connected to said crankshaft, said template configured to position the torque arm to achieve high torque when the piston is at the stroke position that receives high pressures from combustion of gases in said cylinder.

2. The engine of claim 1 wherein the high torque is achieved by having the total of force vectors contribution to turning the crankshaft be at least 25% of the exerted by the piston on the connecting rod.

3. The engine of claim 1 wherein the high torque is achieved by having the total of force vectors contributing to turning the crankshaft is at least 50% of the force exerted by the piston on the connecting rod.

4. The engine of claim 1 wherein the high torque is achieved by having the total of force vectors contributing to turning the crankshaft is at least 80% of the force exerted by the piston on the connecting rod.

5. The engine of claim 1 wherein said common pivot includes a roller and said template includes a channel having a surface for receiving and guiding said roller.

6. The engine of claim 1 further comprising a combustion chamber for receiving combustible fuel and an ignition source for igniting said fuel.

7. The engine of claim 1 wherein the ignition source is a spark plug.

8. The engine of claim 1 further comprising an inlet for receiving combustible fuel that can be ignited by pressurizing it with said piston.

9. The engine of claim 6 wherein the combustible fuel is diesel oil.

10. The engine of claim 1 wherein the template is configured to position the connecting rod such that its longitudinal axis is about 0% angle with respect to the central axis of the cylinder when the combustion pressure in said cylinder is at its maximum level.

11. The engine of claim 1 wherein longitudinal axis of said channel is about coaxial with the longitudinal axis of a connecting rod when the combustion pressure is in said cylinder is at its maximum level.

12. The engine of claim 1 wherein said engine comprises a plurality of elements (a)-(g) in a multi-cylinder engine.

13. The engine of claim 12 wherein said engine is an eight cylinder engine.

14. The engine of claim 12 wherein said engine is a six cylinder engine.

15. The engine of claim 12 wherein said engine is a four cylinder engine.

16. The engine of claim 1 further comprising a flywheel attached to said crankshaft.

17. The engine of claim 1 wherein the crankshaft is rotatably mounted in said engine block.

18. An improved reciprocating internal combustion engine, comprising:
(a) an engine block;
(b) a cylinder defined in said engine block;
(c) a piston slideably disposed for rectilinear movement within said cylinder;
(d) a connecting rod having an inner end pivotally mounted to said piston and an outer end,
(e) a crank shaft having a throw;
(f) a template secured to said engine block;
(g) a torque arm having a first end and a second end, said first end of said torque arm being pivotally connected to said throw of said crankshaft, said second end of said torque arm being pivotally connected to said connecting rod and operatively connected to said template.

19. An improved reciprocating internal combustion engine, said engine comprising:
(a) an engine block;
(b) a cylinder within said engine block;
(c) a piston slidably disposed within said cylinder for rectilinear reciprocal movement within said cylinder between a high dead center position and a low dead center position, said movement caused by combustion of fuel fed into said cylinder, the combustion pressure being at maximum after said piston starts to move down from the high dead center position and gradually declining pressure as said piston moves toward the low dead center position;
(d) a crankshaft, said crankshaft rotatably mounted in said engine block for rotation around a longitudinal crankshaft axis, said crankshaft including a throw;
(e) a torque arm having a connecting rod end and a crank shaft end, said connecting rod end pivotally connected to said outer end of said connecting rod, said crankshaft end pivotally connected to said crankshaft throw;
(f) a template having a channel defined by a channel surface;
(g) a roller operatively connected to the common pivot, said roller riding on said channel surface of said channel; said channel having a first end and second end, said connecting rod, said channel surface and said crankshaft being positioned such that when the combustion pressure in the cylinder is at about its maximum level, the combined value of the vectors transmitting rotational force to the crankshaft is at least 25% of the force exerted by the piston.

20. The engine of claim 19 wherein the combined value is at least 50%.

21. The engine of claim 19 wherein combined value is at least 80%.

22. The engine of claim 19 wherein the channel comprises a plurality of generally straight segments.

23. The engine of claim 19 wherein the channel includes at least one accurate segment.
